(19) United States
(12) Patent Application Publication
(10) Pub. No.: US 2010/0102220 A1
(43) Pub. Date: Apr. 29, 2010

(54) DETECTOR APPARATUS

(75) Inventor: James Andrew Breach, Watford (GB)

Correspondence Address: FOLEY AND LARDNER LLP;SUITE 500, 3000 K STREET NW, WASHINGTON, DC, 20007, US

(73) Assignee: Smiths Detection-Watford Limited

(21) Appl. No.: 12/452,209

(22) PCT Filed: Jun. 13, 2008
(86) PCT No.: PCT/GB2008/002034

§ 371 Date: Dec. 22, 2009

(30) Foreign Application Priority Data
Jun. 26, 2007 (GB) 0712363.1

(51) Int. Cl. B01D 59/44

(52) U.S. Cl. 250/286

(57) ABSTRACT

A detector apparatus supplies samples of gas or vapour to an ion mobility spectrometer (1) via a tube (2). The tube is made of fluorinated ethylene propylene selected to reduce adhesion of substances of interest to the tube, which may also be heated along its length further to reduce adhesion. The tube (2) is closely spaced from the inlet orifice (10) of the spectrometer 1 and opens into an enclosure (3) housing a fan (4), which draws gas and vapour through the tube. The tube (2) may be flexible and extend for some distance to enable sampling from locations remote from the spectrometer (1).

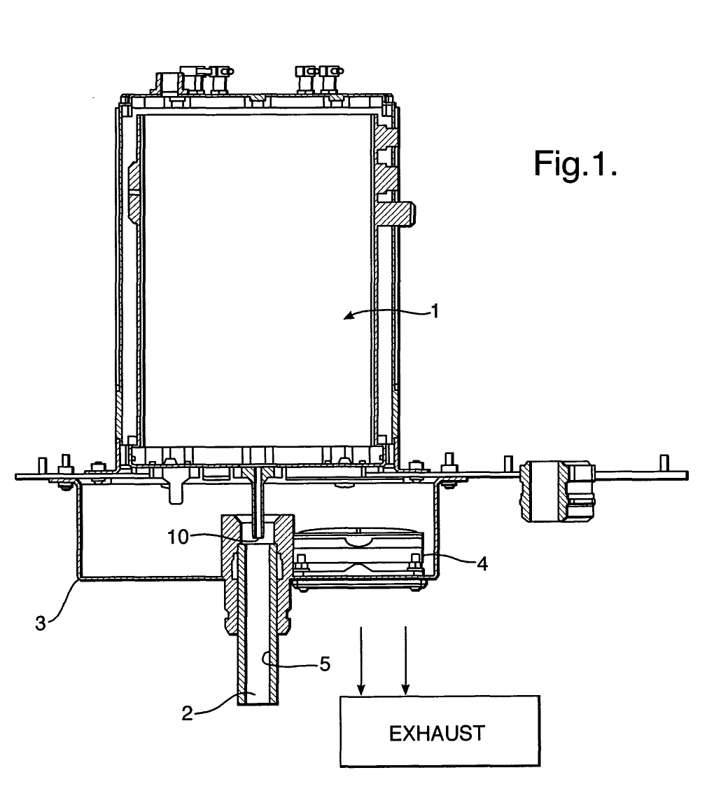

This invention relates to detector apparatus of the kind including a detector and an inlet arrangement.

Currently, optimum performance from gas analysers or detector apparatus, such as IMS detector apparatus can be achieved by using point detection. This technique does not lend itself to use in hazardous environments, where a small enclosed volume needs to be analyzed, or in various other circumstances.

According to one aspect of the present invention there is provided detector apparatus of the above-specified kind, characterised in that the inlet arrangement includes a tube having an internal surface arranged to reduce adhesion of substances of interest, and that the apparatus includes an arrangement for drawing gas or vapour along the tube to the detector.

The internal surface may be of a thermoplastic fluoropolymer and the entire tube may be of a thermoplastic fluoropolymer, such as fluorinated ethylene propylene. Alternatively, the tube may be of a first material and have a layer exposed on its inner surface of a second material different from the first material. The second material may be fluorinated ethylene propylene. The tube may be flexible. The detector may include an ion mobility spectrometer. The inlet arrangement may include an inlet of the detector, the internal diameter of the tube being greater than the external diameter of the inlet, one end of the tube being closely spaced from the inlet, and both the tube and the inlet opening into an enclosure. The arrangement for drawing gas or vapour along the tube may include a fan operable to draw gas or vapour from the tube over the inlet and into the enclosure.

According to another aspect of the present invention there is provided a tube for detector apparatus according to the above one aspect of the present invention.

Detector apparatus according to the present invention will now be described, by way of example, with reference to the accompanying drawing, which shows the detector schematically.

The apparatus comprises a detector or sensor 1, such as an ion mobility spectrometer (IMS), and a length of tube 2 connected with the sensor. Other forms of sensor would be possible. Attached to the sensor 1 is a sample enclosure 3, which contains equipment, such as a fan 4, for creating a high volume, low-pressure airflow within the sample tube 2. The internal end of the tube 2 is mounted in a cylindrical mounting sleeve and is axially aligned with an inlet orifice 10 of the detector 1. The internal end of the tube 2 is spaced a short distance from the inlet orifice 10 and the internal diameter of the tube is substantially greater than the external diameter of an inlet orifice. The inlet orifice 10 projects a short distance into the mounting sleeve so that gas and vapour emerging from the tube 2 flows over and around the outside of the orifice, with some gas or vapour entering the orifice and the remainder flowing into the enclosure 3.

The tube 2 could be flexible or rigid, and has an inner surface 5 arranged to minimise surface adhesion. Without such a surface some chemical compounds could stick to the surfaces of the tube causing the sensor to give false alarms or to reduce the sensitivity of detection. The tube 2 is preferably made entirely of a thermoplastic fluoropolymer, such as FEP (fluorinated ethylene propylene), which is available in extruded form and is suitable for passing all chemical warfare agents in vapour form over short distances, which could be up to about 2 m. Alternatively, the main body of the tube could be of a first material and it could be coated internally to provide a non-stick layer exposed on its inner surface of a second material different from the first material, such as of FEP. The sample tube 2 may be heated along its full length further to reduce adhesion of the chemicals of interest and thereby to optimise the detection performance.

When functioning, large volumes of fast moving sample air are transferred from the sampling point, down the tube 2, which in turn passes over the inlet 10 to the sensor 1 (where it is analysed) and through the sample enclosure 3 from where it is exhausted to atmosphere.

This arrangement enables the sampling point to be moved away remotely from the sensor 1. This arrangement gives rise to a range of new applications.

In particular the arrangement is particularly suitable for sampling air to detect hazardous compounds, in either gas or vapour form, since the invention enables a remote sampling system to be provided connected to a gas analyser or detector.

The arrangement could be used for discrete, unobtrusive sampling. For example, a chemical early warning system designed for use in public spaces would require air sampling, where the location and nature of such system may cause unnecessary public concern.

Alternatively, the arrangement allows the remote sampling point to be inserted into a potentially hazardous environment, such as an enclosed explosive atmosphere, or an enclosed radioactive environment or other enclosed atmosphere, thought to constitute a risk to human life.

Another application for the arrangement of the present invention is sampling in small-restricted volumes, into which a standard detector cannot. This could for example, be within an automated manufacturing environment, looking for tiny leaks within chemical containers/cylinders or vials or the like.

1. Detector apparatus including a detector and an inlet arrangement, characterised in that the inlet arrangement includes a tube (2) having an internal surface (5) arranged to reduce adhesion of substances of interest, and that the apparatus includes an arrangement (4) for drawing gas or vapour along the tube (2) to the detector (1).

2. Detector apparatus according to claim 1, characterised in that the internal surface is of a thermoplastic fluoropolymer.

3. Detector apparatus according to claim 1 or 2, characterised in that the entire tube is of a thermoplastic fluoropolymer.

4. Detector apparatus according to claim 2 or 3, characterised in that the thermoplastic fluoropolymer is fluorinated ethylene propylene.

5. Detector apparatus according to claim 1 or 2, characterised in that the tube is of a first material and has a layer exposed on its inner surface of a second material different from the first material.

6. Detector apparatus according to claim 5, characterised in that second material is fluorinated ethylene propylene.

7. Detector apparatus according to any one of the preceding claims, characterised in that the tube is flexible.

8. Detector apparatus according to any one of the preceding claims, characterised in that the tube (2) is heated.

9. Detector apparatus according to any one of the preceding claims, characterised in that the detector includes an ion mobility spectrometer.

10. Detector apparatus according to any one of the preceding claims, characterised in that the inlet arrangement includes an inlet (10) of the detector (1), that the internal diameter of the tube (2) is greater than the external diameter of the inlet (10), that one end of the tube (2) is closely spaced from the inlet (10), and that both the tube and the inlet open into an enclosure (3).

11. Detector apparatus according to claim 10, characterised in that the arrangement for drawing gas or vapour along the tube includes a fan (4) operable to draw gas or vapour from the tube (2) over the inlet (10) and into the enclosure (3).

12. A tube for detector apparatus according to any one of the preceding claims.
